(19) United States
(12) Patent Application Publication
(10) Pub. No.: US 2006/0086000 A1
(43) Pub. Date: Apr. 27, 2006

(54) Dryer and method for controlling the same

(75) Inventor: Jung Ho Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/175,221

(22) Filed: Jul. 7, 2005

(30) Foreign Application Priority Data
Oct. 26, 2004 (KR) 2004-85809

(51) Int. Cl. F26B 21/00; F26B 13/10; F26B 21/06

(52) U.S. Cl. 34/524; 34/531; 34/543

(57) ABSTRACT

A dryer and a method for controlling the same, wherein an alert is generated to inform the user that the dryer is operating abnormally, and even if a malfunction occurs in a switch provided for preventing overheating of a heater in the dryer when the dryer is operating abnormally, the malfunction is prevented from causing further risk. The dryer includes a heater, an exhaust pipe, a switch, and a controller. The heater is provided for heating the air. The heated air flows through the exhaust pipe. The switch is turned off to deactivate the heater when temperature of the heater is outside of a preset temperature range. If the switch is turned off a predetermined number of times or more while the heater is in operation, the controller determines that flow of the heated air is abnormal, and deactivates the heater.

### CROSS-REFERENCE TO RELATED APPLICATION

This application claims priority from Korean Patent Application No. 2004-85809, filed on Oct. 26, 2004 in the Korean Intellectual Property Office, the disclosure of which is incorporated herein by reference.

### BACKGROUND OF THE INVENTION

1. Field of the Invention

Apparatuses consistent with the present invention relate to a dryer, and more particularly, to a dryer for drying clothes or grain using the air heated by a heater and a method for controlling the same.

2. Description of the Related Art

Dryers are used to evaporate moisture in objects to be dried. Dryers can be classified into grain dryers for industrial use and clothes dryers for household use.

An exemplary conventional dryer will now be described. If a drying mode is selected in a conventional clothes dryer, the dryer performs drying at a low speed. When 90% of the drying procedure is completed, lint detached from clothes in the course of washing may circulate together with hot air inside the clothes dryer and then be collected on a lint filter in the dryer.

Since clothes are typically white and a filter and a filter cover are typically black, the change in color of the filter, as more lint is collected thereon, allows easy detection of filter clogging.

As lint is collected on the filter, the user determines the degree to which the filter is clogged, based on the degree of filter clogging as indicated by the filter cover, and cleans the filter if the filter is severely clogged.

It is generally recommended that the user clean the filter each time the clothes dryer is used. However, dryer users may disregard filter cleaning due to the inconvenience and annoyance of having to clean the filter each time the dryer is used. Also, although the degree to which the filter is clogged increases with the use of the dryer, users cannot readily determine the degree to which the filter is clogged simply by looking at the filter, thereby reducing the frequency of filter cleaning. As the amount of lint collected on the filter increases, the time required to complete the drying increases, thereby raising power consumption. If the filter is severely clogged, fine lint particles may not be collected on the filter, and instead may circulate in the dryer to be attached to clothes or to the inside surface of the dryer, thereby contaminating clothes.

### SUMMARY OF THE INVENTION

It is an aspect of the invention to provide a dryer and a method for controlling the same, wherein an alert is generated to inform the user that the dryer is operating abnormally.

It is another aspect of the invention to provide a dryer and a method for controlling the same, in which even if a malfunction occurs in a switch provided for preventing overheating of a heater in the dryer when the dryer is operating abnormally, the malfunction is prevented from causing further risk.

In accordance with an aspect of the invention, a dryer is provided, which comprises a heater, an exhaust pipe, a switch, and a controller. The heater is provided for heating the air. The heated air flows through the exhaust pipe. The switch is turned off to deactivate the heater when temperature of the heater is out of a preset temperature range. If the switch is turned off a predetermined number of times or more while the heater is in operation, the controller determines that flow of the heated air is abnormal and deactivates the heater.

In accordance with another aspect of the invention, there is provided a method for controlling a dryer, in which a heater is activated to heat air flowing through an exhaust pipe; a switch is turned off to deactivate the heater when temperature of the heater is out of a preset temperature range while the heater is in operation; and it is determined that flow of the air through the exhaust pipe is abnormal and the heater is deactivated if the switch is turned off a predetermined number of times or more while the heater is in operation.

In accordance with yet another aspect of the invention, a dryer is provided, which comprises a heater, an exhaust pipe, a filter, first and second switches, and a controller. The heater is provided for heating air to dry an object in the dryer. The heated air flows through the exhaust pipe. The filter is provided in the exhaust pipe to filter out foreign substances in the heated air flowing through the exhaust pipe. The first switch is provided to turn on/off power to the heater. The second switch is turned off to deactivate the heater when temperature of the heater exceeds a preset temperature range. The controller turns on the first and second switches to activate the heater, and determines that flow of the air through the filter is not smooth and deactivates the heater if the second switch is turned on and off a predetermined number of times or more while the heater is in operation.

### BRIEF DESCRIPTION OF THE DRAWINGS

The above and/or other aspects of the invention will become apparent and more readily appreciated from the following description of the exemplary embodiments, taken in conjunction with the accompanying drawings of which:

FIG. 1 is a block diagram of a dryer according to an exemplary embodiment of the present invention;

FIGS. 2A to 2D are schematic diagrams of switching states of first and second switches in the dryer according to an exemplary embodiment of the present invention; and

FIG. 3 is a flow chart of a method for controlling a dryer according to an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

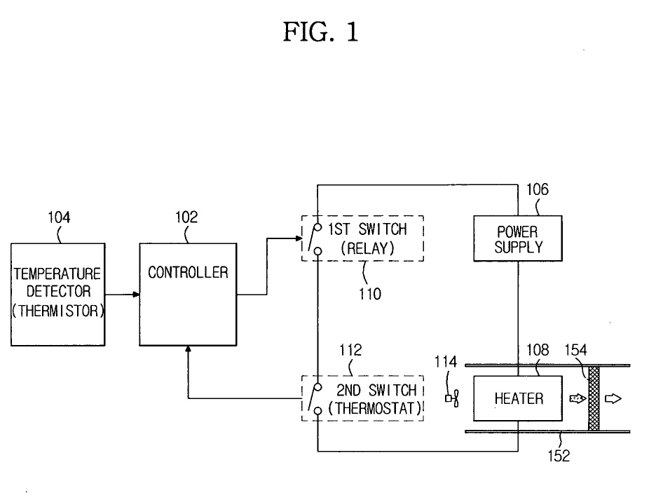

FIG. 1 is a block diagram of a dryer according to an exemplary embodiment of the present invention. As shown in FIG. 1, the dryer includes a controller 102, a temperature detector 104, a power supply unit 106, a heater 108, a first switch 110, a second switch 112, and a fan 114. The temperature detector 104 and the second switch 112 are connected to respective inputs of the controller 102, and the first switch 110 is connected to an output of the controller 102. The temperature detector 104 is provided to detect a temperature of the air exiting the dryer (i.e., exhaust air temperature). The temperature detector 104 may include a thermistor. The first switch 110 is provided to activate or deactivate the heater 108. The first switch 110 may include a relay. The first switch 110, the second switch 112, the heater 108, and the power supply unit 106, are connected in series to form a closed circuit. Thus, power is supplied to the heater 108 to heat the air in the dryer only if the first and second switches 110 and 112 are on. The fan 114 circulates the air heated by the heater 108 so that the heated air is used to dry an object in the dryer.

The first switch 110 is controlled directly by the controller 102. The controller 102 turns on the first switch 110 in order to activate the heater 108 and start the drying cycle. The second switch 112 may preferably be composed of a thermostat such that the second switch 112 is turned on or off automatically according to a temperature of the heater 108. Due to the characteristics of the thermostat, the second switch 112 is automatically turned off when the temperature of the heater 108 reaches a preset overheat temperature so as to prevent a fire caused by the overheating of the heater 108. If the heater 108 is at an appropriate temperature, the thermostat (i.e., the second switch 112) remains on so that the heater 108 continues heating.

Even if the second switch 112, which includes the thermostat, is provided to prevent overheating of the heater 108, the overheating of the heater 108 cannot be prevented if the thermostat malfunctions.

To overcome this problem, in an exemplary embodiment of the present invention, the controller 102 detects a potential difference between both ends of the second switch 112 with the second switch 110 being turned on by the controller 102 to perform the drying cycle, and determines, based on the detected potential difference, whether the dryer is in normal operation. If the controller 102 determines that the dryer is in an abnormal operation state, the controller 102 turns off the first switch 110 to prevent the heater 108 from continued heating, and generates an alert to inform the user of the abnormal operation state in order to ensure safe operation of the dryer.

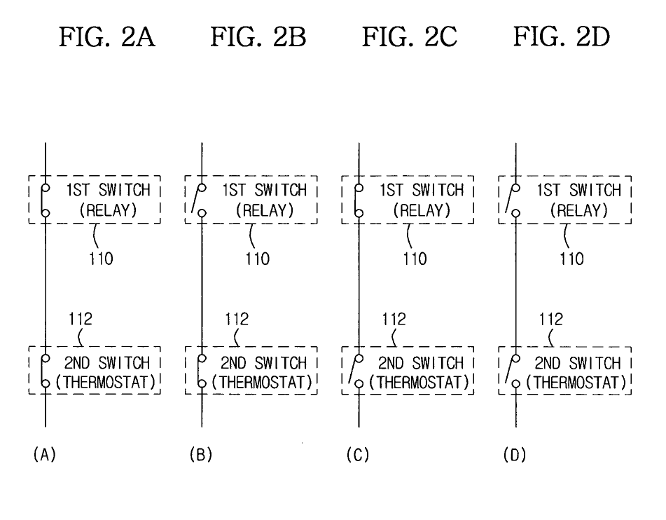

FIGS. 2A to 2D are schematic diagrams of switching states of the first and second switches 110 and 112 in the dryer according to an exemplary embodiment of the present invention. The following table shows the relationship between the switching states of the first and second switches 110 and 112 and the potential difference between both ends of the second switch 112.

TABLE 1

| | | | POTENTIAL DIFFERENCE |
|---|---|---|---|
| | 1ST SWITCH | 2ND SWITCH | BETWEEN BOTH ENDS OF |
| | 110 | 112 | 2ND SWITCH 112 |
| (A) | ON | ON | ZERO |
| (B) | OFF | ON | |
| (C) | OFF | OFF | |
| (D) | ON | OFF | NON-ZERO |

As shown in FIGS. 2A to 2D and Table 1, there are four combinations (A), (B), (C) and (D) of the on/off states of the first and second switches 110 and 112. The first combination (A) is a switching state in which both the first and second switches 110 and 112 are on, as shown in FIG. 2A, the second combination (B) is a switching state in which the first switch 110 is off and the second switch 112 is on, as shown in FIG. 2B, the third combination (C) is a switching state in which both the first and second switches 110 and 112 are off, as shown in FIG. 2C, and the fourth combination (D) is a switching state in which the first switch 110 is on and the second switch 112 is off, as shown in FIG. 2D. The potential difference between both ends of the second switches 112 is non-zero only in the fourth switching state (D), and it is zero in the other switching states (A), (B), and (C). Here, it is assumed that the potential difference between both ends of the second switch 112 is caused by a sufficiently high resistance between both ends thereof when the second switch 112 is off, while disregarding a potential difference caused by inherent turn-on resistance of each switch.

In the first switching state (A), both the first and second switches 110 and 112 are on so that no potential difference exists between both ends of the second switch 112. In the second and third switching states (B) and (C), the first switch 110 is off so that the power from the power supply unit 106 is interrupted and thus no potential difference exists between both ends of the second switch 112. On the contrary, in the fourth switching state (D), the first switch 110 is on and the second switch 112 is off so that most of the power supply voltage from the power supply 106 is applied between both ends of the second switch 112. Based on the voltage (i.e., the potential difference) across both ends of the second switch 112, the controller 102 determines that the second switch 112 is off.

The second switch 112, which includes a thermostat or the like, is turned on only when the temperature of the heater 108 is within a preset temperature range, and is turned off when the temperature of the heater 108 is outside of the preset temperature range. Accordingly, the off state of the second switch 112 indicates that the temperature of the heater 108 is outside of the preset temperature range. The temperature of the heater 108 outside of the preset temperature range indicates that the heater 108 has overheated.

The controller 102 determines whether to activate the heater 108, based on the exhaust air temperature, i.e., the temperature of the exhaust air, flowing through the object in the dryer by air circulation of the fan 114, rather than based on the temperature of the heater 108. The determination as to whether to activate the heater 108, without considering the temperature of the heater 108, may cause the dryer to enter an abnormal operation state in the following cases.

In order to dry an object in the dryer, the dryer must take in the air through an intake vent, heat it through the heater 108, and circulate the heated air over the object in the dryer, and then exhaust the air used for the drying through an exhaust vent. One case where the dryer enters an abnormal operation state as described above is when the distance between the intake and exhaust vents (i.e., the length of an exhaust pipe) is too long. In this case, the exhaust air temperature is lowered allowing the controller 102 to continue to activate the heater 108 even if the intake air is sufficiently heated by the heater 108. This may cause the heater 108 to overheat so that the second switch 112 is frequently activated.

Another case where the dryer enters an abnormal operation state is when the exhaust pipe is clogged. For example, if a filter provided in the exhaust pipe at a certain position thereof is clogged with foreign substances, preventing the air from being properly (i.e., smoothly) exhausted, the exhaust air temperature may be low while the internal temperature of the exhaust pipe is continuously raised. This causes the controller 102 to keep the first switch 110 on and thus to keep the heater 108 active. Also in this case, the heater 108 overheats so that the second switch 112 is frequently activated.

Yet another case where the dryer enters an abnormal operation state is when the intake air is excessively leaked during the air exhausting procedure. If the intake air is leaked without being exhausted normally, the exhaust air temperature may be low while the internal temperature of the exhaust pipe is continuously raised in the same manner as when the filter is clogged. This causes the controller 102 to keep the first switch 110 on and thus to keep the heater 108 active. Also in this case, the heater 108 overheats so that the second switch 112 is frequently activated.

If there is a failure in the dryer or the exhaust pipe has a design error, the heater 108 may overheat so that the second switch 112 is activated more frequently than when the second switch 112 is in a normal operation state. The frequent activation of the second switch 112 indicates that the second switch 112 is frequently turned off. Accordingly, in an exemplary embodiment of the present invention, the controller 102 detects the occurrence of a structural or operational error in the dryer, based on the frequent turning off of the second switch 112.

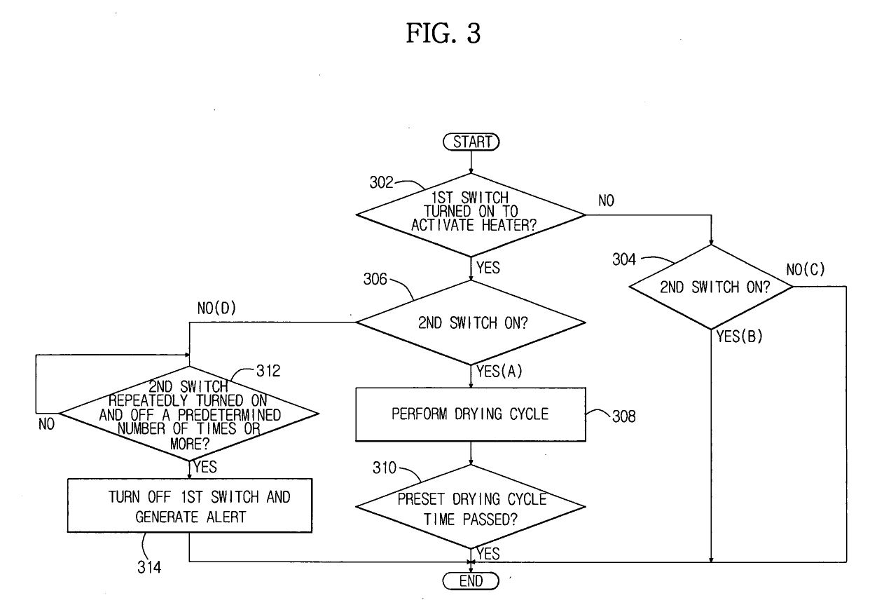

FIG. 3 is a flow chart of a method for controlling a dryer according to an exemplary embodiment of the present invention. As shown in FIG. 3, if the first switch 110 is turned off, the controller 102 terminates the drying cycle, regardless of whether the second switch 112 is on or off (302 and 304). This corresponds to the second switching state (B) as shown in FIG. 2B, or the third switching state (C) as shown in FIG. 2C.

On the contrary, if the controller 102 turns on the first switch 110 to activate the heater 108, the controller 102 determines whether the second switch 112 is on or off (306). If the second switch 112 is turned on, the heater 108 is activated to perform the drying cycle (308). This corresponds to the first switching state (A) as shown in FIG. 2A. The drying cycle is terminated after being performed for a preset time (310).

If the second switch 112 is turned off when the first switch 110 has been turned on by the controller 102 to activate the heater 108, the controller 102 deactivates the heater 108 to terminate the drying. The controller 102 detects the potential difference between both ends of the second switch 112 and determines whether the second switch 112 is off, based on the detected potential difference. If the second switch 112 is repeatedly turned off a predetermined number of times or more while the first switch 110 is on, the controller 102 determines that a structural or operational error has occurred in the dryer (312). Then, the controller 102 turns off the first switch 110 to cut the power to the heater 108, and generates an alert to inform the user of the error occurrence in the dryer (314). This corresponds to the switching state (D) as shown in FIG. 2D. For correct determination of the occurrence of an error in the dryer, the number of times the second switch 112 is turned off for a preset time is determined through experimental detection of the number of times using controlled malfunction of the dryer, and a lookup table corresponding to the determined data is provided to the controller 102. In an actual drying cycle, the controller 102 refers to the lookup table to discriminate a normal operation state from an error occurrence state.

As is apparent from the above description, the present invention provides a dryer and a method for controlling the same, which have the following advantages. An alert is generated to inform the user that the dryer is operating abnormally, so that the user can be made aware of a risk that may be caused by the abnormal operation of the dryer. In addition, even if a malfunction occurs in a switch provided for preventing overheating of a heater in the dryer when the dryer is operating abnormally, the malfunction is prevented from causing further risk.

Although exemplary embodiments of the present invention have been shown and described, it would be appreciated by those skilled in the art that changes may be made in the exemplary embodiments without departing from the principles and spirit of the invention, the scope of which is defined in the claims and their equivalents.

What is claimed is:

1. A dryer comprising:
a heater which heats air;
an exhaust pipe through which the heated air flows;
a switch which is turned off to deactivate the heater if a temperature of the heater is outside of a preset temperature range; and
a controller which determines that a flow of the heated air is abnormal and deactivates the heater if the switch is turned off at least a predetermined number of times while the heater is in operation.

2. The dryer according to claim 1, wherein the switch comprises a thermostat that is turned on and off according to the temperature of the heater.

3. The dryer according to claim 1, wherein the controller determines whether the switch is turned off based on a potential difference between ends of the switch.

4. The dryer according to claim 1, further comprising:
a filter which is provided in the exhaust pipe to filter foreign substances in the heated air flowing through the exhaust pipe,
wherein the controller determines that the flow of the heated air through the filter is not smooth due to the foreign substances in the filter if the switch is turned off at least the predetermined number of times while the heater is in operation.

5. A method for controlling a dryer, the method comprising:
activating a heater to heat air flowing through an exhaust pipe;
turning off a switch to deactivate the heater if a temperature of the heater is outside of a preset temperature range while the heater is in operation; and
determining that flow of the air through the exhaust pipe is abnormal and deactivating the heater if the switch is turned off at least a predetermined number of times while the heater is in operation.

6. The method according to claim 5, wherein the determining that the flow of the air through the exhaust pipe is abnormal is caused by an abnormal installation structure of the exhaust pipe.

7. The method according to claim 5, further comprising determining that the switch is turned off based on a potential difference between ends of the switch.

8. The method according to claim 7, wherein the deactivating the heater if the switch is turned off at least the predetermined number of times comprises turning off another switch which controls a power supplied to the heater.

9. A dryer comprising:
a heater which heats air to dry an object in the dryer;
an exhaust pipe through which the heated air flows;
a filter which is provided in the exhaust pipe to filter foreign substances in the heated air flowing through the exhaust pipe;
a first switch which controls a power supplied to the heater;
a second switch which is turned off to deactivate the heater if a temperature of the heater is outside of a preset temperature range; and
a controller which turns on the first and second switches to activate the heater, and determines that flow of the air through the filter is not smooth and deactivates the heater if the second switch is turned on and off at least a predetermined number of times while the heater is in operation.

10. The dryer according to claim 9, wherein the first switch comprises a relay which is turned on by the controller to supply power to the heater.

11. The dryer according to claim 9, wherein the second switch comprises a thermostat which is turned on and off according to the temperature of the heater.

12. The dryer according to claim 9, wherein the controller determines that the second switch is turned off based on a potential difference between ends of the second switch.

13. The dryer according to claim 12, wherein the potential difference is zero if the first switch and the second switch are on, the first switch is off and the second is on, and the first switch and the second switch are off, and the potential difference is non-zero if the first switch is on and the second switch is off.
